(19) United States
(12) Patent Application Publication
(10) Pub. No.: US 2008/0251493 A1
(43) Pub. Date: Oct. 16, 2008

(54) Method for manufacturing printed wiring board with built-in capacitor

(76) Inventor: Garo Miyamoto, Tsukuba-Shi (JP)

Correspondence Address: JACOBSON HOLMAN PLLC, 400 SEVENTH STREET N.W., SUITE 600, WASHINGTON, DC, 20004, US

(21) Appl. No.: 12/000,962

(22) Filed: Dec. 19, 2007

(30) Foreign Application Priority Data
Dec. 21, 2006 (JP) 2006-344494

(51) Int. Cl. H01G 9/00

(52) U.S. Cl. 216/6

(57) ABSTRACT

There is provided a method for manufacturing a wiring board with built-in capacitors in which small high-frequency capacitors, decoupling capacitors, and EMI filter capacitors can be built with precision by using the same method. The method includes preparing an insulating base material 1 having a first metal foil 2 on one side and a second metal foil 3 on the other side; providing an opening in the first metal foil, the opening serving as a metal mask 7; using the metal mask to remove the insulating base material exposed in the opening in the metal mask in such a way that a continuous inclined surface is provided from the periphery toward the center of the metal mask; removing the insulating base material, the surface of which is inclined, until the second metal foil is exposed, the removed portion having a diameter smaller than the metal mask; forming a dielectric layer 10 by a printing method in such a way that the dielectric layer covers the second metal foil exposed by removing the insulating base material, the covered area being smaller than the metal mask but larger than the second metal foil exposed by removing the insulating base material; and forming a conductive layer on the dielectric layer and using the conductive layer as a first electrode and the surface of the second metal foil that is in contact with the dielectric layer as a second electrode.

### BACKGROUND OF THE INVENTION

1. Field of the Invention

The present invention relates to the structure of a printed wiring board and a method for manufacturing the same, particularly to a method for manufacturing a printed wiring board with a built-in capacitor structure.

2. Related Art

In recent years, a printed wiring board is required to be lighter, and wiring lines therein are required to be thinner and packed at a higher density to mount smaller, multipin-type BGAs (Ball Grid Arrays), PGAs (Pin Grid Arrays), and CSPs (Chip Size Packages).

However, as more wiring lines are packed at a higher density, wiring patterns get closer to one another, possibly resulting in problems of crosstalk noise between the wiring lines and variation in potential in the power supply line, the ground line and the like.

In particular, when semiconductor elements, electronic parts and the like that require high-speed switching operations are mounted, crosstalk noise is likely produced as the frequency increases, and switching noise is produced when a switching element is turned on and off at a high speed. Such noises likely result in variation in potential in the power supply line and the like and hence undesirable reduction in reliability of the operation of the mounted semiconductor elements and the like.

To stabilize the power supply voltage and reduce the switching noise and the like, a capacitive element, such as a chip capacitor, is incorporated in a semiconductor package on which a semiconductor element is mounted to “decouple” the power supply line and the like.

In a typical approach, a chip capacitor is surface-mounted in the semiconductor package by soldering or the like on the same side as or the side opposite to the side where the semiconductor element is mounted. An anti-noise EMI filter capacitor has also been frequently used in accordance with higher speed in signal transmission.

In a mobile apparatus that requires more advanced functions and higher speed, such as a mobile phone, the space in the apparatus or the area on the wiring board prepared for mounting parts has been increasingly reduced. An example of electronic parts for mobile phones that have been increasingly reduced in size is a capacitor. Representative examples of the small capacitor for a mobile phone are the type 0402 (size: 0.4 mm long by 0.2 mm wide by 0.2 mm high) and the type 0603 (size: 0.6 mm long by 0.3 mm wide by 0.3 mm high).

Related art has, for example, the following problems: further reduction in size beyond the dimensions described above is difficult in terms of manufacturing and mounting of parts, and the fact that approximately 250 capacitors are incorporated in a mobile phone increases the parts cost and the mounting cost.

To address such problems, there has been developed a wiring board with built-in parts as a new mounting form in which parts are built in the wiring board to provide a new mounting area and space for three-dimensional mounting. As the wiring board with built-in parts, there has been developed technologies by which passive parts, such as resistors, capacitors, and inductors, are built in a substrate or a wiring board made of a glass epoxy resin, a ceramic material, or the like, and part of these technologies have been in actual use.

The wiring boards with built-in capacitors described in Japanese Patent Laid-Open No. 2004-235490 (page 4, paragraph [0031]) and Japanese Patent Laid-Open No. 2004-39908 (page 5, paragraph [0031]) are made of an electrodeposited polyimide resin or the like as the dielectric material. Since the relative dielectric constant of polyimide is approximately 3.3, it is possible to build and pack small high-frequency capacitors, each having a capacitance of approximately 0.1 to 1 pF, at a high density.

However, the process is complex and a large area is required to obtain a capacitance of approximately 0.005 to 0.1 μF necessary for a decoupling capacitor, so that the above technologies are not suitable for achieving a higher density. Furthermore, a multilayer wiring board has a design constraint, that is, the fact that electrodeposited leads are necessary limits the location where the dielectric material is formed.

The wiring board with built-in capacitors described in Japanese Patent Laid-Open No. 2003-304060 (page 2, paragraph [0008]) requires a large area to increase the capacitance because the fact that the dielectric material is filled in a hole increases the distance between the electrodes. Such a technology is not suitable for achieving a higher density as well.

To address these problems, the present applicant has filed a patent application describing a method for manufacturing a wiring board in which small high-frequency capacitors, each having a capacitance of approximately 0.1 to 1 pF, decoupling capacitors, each having a capacitance of approximately 0.005 to 0.1 μF, and EMI filter capacitors are simultaneously built at a high density (Japanese Patent Application No. 2006-133346, (hereinafter referred to as “prior application”)). The prior application, however, does not always provide a sufficient solution because each of the EMI filter capacitors needs to be fabricated to have a precise capacitance value.

FIGS. 2(1) to 2(6) are cross-sectional process diagrams showing the method for manufacturing a wiring board with built-in capacitors described in the prior application. First, as shown in FIG. 2(1), a so-called double-sided copper-clad laminate 24 is prepared. The double-sided copper-clad laminate 24 includes a flexible insulating base material 21 made of polyimide or the like, a first conductive layer 22 on one side and a second conductive layer 23 on the other side, each of the first and second conductive layer formed of a copper foil or the like. A resist layer 25 is formed to form a metal mask having openings at the locations where holes and grooves are formed at predetermined positions in the first conductive layer 22 by using etching in a typical photofabrication approach. This process is preferably carried out by using a laminator or the like to attach a dry film resist or the like. In this method, 25 μm-thick polyimide was used as the base material.

Then, as shown in FIG. 2(2), the resist layer 25 is used to form a metal mask 27 having openings 26 at the locations where holes and grooves are formed by using etching in a typical photofabrication approach.

Then, as shown in FIG. 2(3), any of laser processing, plasma etching, resin etching and the like or any combination thereof is used to etch away the flexible insulating base material 21 exposed in the openings 26 provided for a hole 28 for forming a capacitor and a hole 29 for forming a via hole, so that the hole 28 for forming a capacitor and the hole 29 for forming a via hole, each of the holes having a bottom where the hole reaches the conductive layer 23 on the other side, are formed.

In this process, holes having various shapes are simultaneously formed using chemical solution-based resin etching to taper the wall of each of the holes at 45 degrees or smaller. In this case, considering that the resin etching rate varies depending on the type of the polyimide film, preferred examples of the flexible insulating base material 21 are polyimide films obtained by polycondensation between pyromellitic dianhydride and aromatic diamine (Kapton manufactured by DuPont, USA, and Apical manufactured by Kanegafuchi Chemical Industry Co., Ltd., for example) and similarly structured thermoplastic polyimide.

The reason why the wall of the hole is tapered at 45 degrees or smaller is to allow paste to reach the tapered wall when dielectric material is applied in the following process so as to reliably prevent short circuit in the capacitor structure. Ink jetting can be adequately used by the fact that the positional shift tolerance for the dielectric material application is ±10 μm because 25 μm-thick polyimide is used as the base material and the wall of the hole is tapered at 45 degrees or smaller. In this process, the design difference between the upper and lower diameters of the hole is 40 μm.

Then, as shown in FIG. 2(4), ink jetting is used to apply a dielectric material 30 on the second conductive layer exposed in the hole 28, followed by thermal cure. In this process, to prevent short circuit in the capacitor structure, it is necessary to seamlessly draw the dielectric material 30 on the second conductive layer 23. To this end, as shown in FIG. 2(4), the dielectric material is drawn in such a way that it reaches the wall of the hole formed in the flexible insulating base material 21.

Since a decoupling capacitor requires an area of approximately 100 mm² in the method of the present invention, it is also effective to use screen printing for the bottom while using ink jetting for the wall.

When an electrodeposited polyimide is used as the dielectric material, the portion where polyimide should not be precipitated must be protected with a masking tape or the like. Use of paste having a high dielectric constant, however, allows application only at an arbitrary location by ink jetting or screen printing, so that the process can be simplified and an arbitrary capacitance value can be obtained by changing the relative dielectric constant, the film thickness, and the application area of the dielectric material.

Since the ink for ink jetting includes more solvent than that contained in the paste for screen printing, reduction in film thickness after thermal cure is accordingly greater. Therefore, the thickness of the dielectric material formed by ink jetting is smaller than that of the dielectric material formed by screen printing even when the ink used in the ink jetting has the same dielectric constant as that in the screen printing, so that a high-capacitance capacitor can be formed.

When the dielectric material is drawn by ink jetting, irregularities of approximately 1.5 μm are created in the surface after the first drawing. However, repeating the drawing three times reduces the size of the irregularities in the surface to approximately 0.2 μm when the film thickness is approximately 3.5 μm. In this process, to reliably prevent short circuit due to pinholes, the drawing is repeated five times to achieve a film thickness of 5 μm.

Then, as shown in FIG. 2(5), a conducting process is carried out on the first conductive layer 22, the dielectric material 30 applied on the second conductive layer 23 exposed in the hole 28, the wall of the hole 28, the upper surface of the second conductive layer 23 exposed in the hole 29, and the wall of the hole 29 to form a plated film 31.

Then, as shown in FIG. 2(6), etching in a photofabrication approach is applied on the first conductive layer 22, the second conductive layer 23, and the plated film 31 to form circuit patterns 32 and 33. A double-sided flexible wiring board 34 with the built-in capacitor structure is thus provided.

### SUMMARY OF THE INVENTION

As seen from the above description, there is a need for a method for manufacturing a wiring board in which small high-frequency capacitors, each having a capacitance of approximately 0.1 to 1 pF, decoupling capacitors, each having a capacitance of approximately 0.005 to 0.1 μF, and EMI filter capacitors are simultaneously built at a high density.

To increase the capacitance, it is important to reduce the distance between the electrodes, that is, reduce the thickness of the dielectric material. Alternatively, a larger relative dielectric constant of a dielectric material can increase the capacitance even if the area of the dielectric material is small. In the technologies of related art, small-capacitance capacitors and large-capacitance capacitors cannot be fabricated with precision in the same method.

The present invention has been made in view of the above points. An object of the present invention is to provide a method for manufacturing a printed wiring board with built-in capacitors. According to this method, small high-frequency capacitors, decoupling capacitors, and EMI filter capacitors can be formed in the same method.

To achieve the above object, the present invention provides a method for manufacturing a printed wiring board with built-in capacitors, the method including:

the first process of preparing an insulating base material having a first metal foil on one side and a second metal foil on the other side;

the second process of providing an opening in the first metal foil, the opening serving as a metal mask;

the third process of using the metal mask to remove the insulating base material exposed in the opening in the metal mask in such a way that a continuous inclined surface is provided from the periphery toward the center of the metal mask;

the fourth process of removing the insulating base material, the surface of which is inclined, until the second metal foil is exposed, the removed portion having a diameter smaller than the metal mask;

the fifth process of forming a dielectric layer by a printing method in such a way that the dielectric layer covers the second metal foil exposed by removing the insulating base material, the covered area being smaller than the metal mask but larger than the second metal foil exposed by removing the insulating base material; and

the sixth process of forming a conductive layer on the dielectric layer and using the conductive layer as a first electrode and the surface of the second metal foil that is in contact with the dielectric layer as a second electrode.

The above features of the present invention provide the following advantages.

According to the present invention, by removing the insulating base material and removing the remaining film at the bottom of the hole using a laser, a step can be formed in the wall. By allowing the applied dielectric layer to reach the step in the wall of the hole, the area of the electrodes of the capacitor can be defined with precision and short circuit in the capacitor structure can be reliably prevented. Furthermore, since a printing method, such as ink jetting and screen printing, is used to form the dielectric layer at the bottom of the hole, small-area capacitors having various capacitance values can be formed at arbitrary locations.

As a result, it is possible to stably manufacture a printed wiring board at a low cost in which small high-frequency capacitors, each having a capacitance of approximately 0.1 to 1 pF, decoupling capacitors, each having a capacitance of approximately 0.005 to 0.1 μF, and EMI filter capacitors are built with precision by using the same method.

### BRIEF DESCRIPTION OF THE DRAWINGS

FIGS. 1(1) to 1(7) are manufacturing process diagrams showing an embodiment of the present invention; and

FIGS. 2(1) to 2(6) are manufacturing process diagrams showing a conventional method.

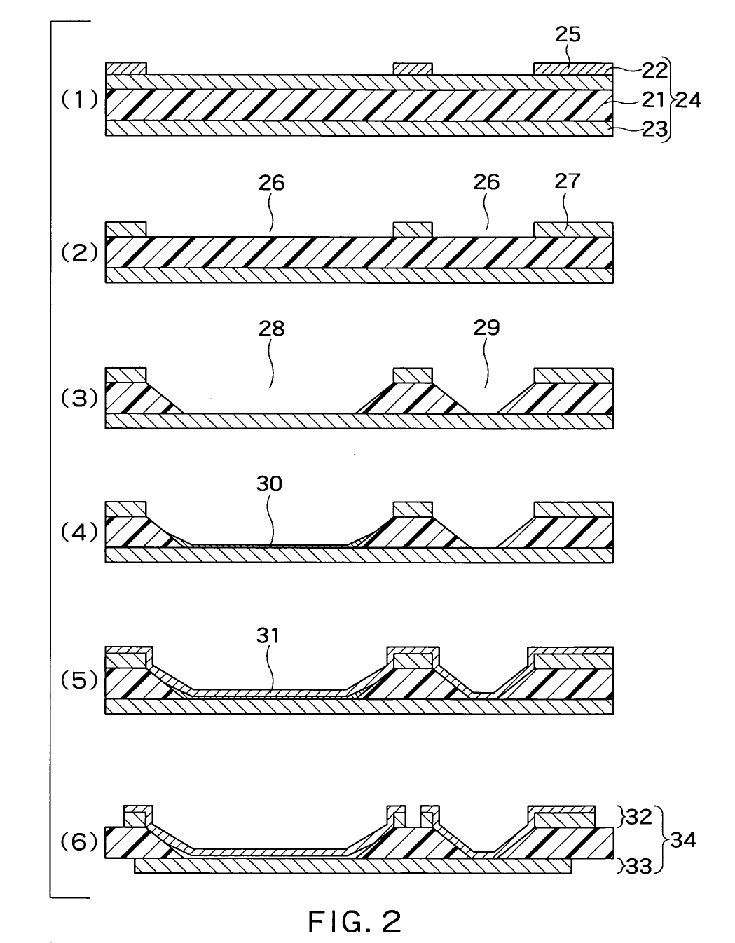

### DETAILED DESCRIPTION OF THE INVENTION

An embodiment of the present invention will be described below with reference to the accompanying drawings.

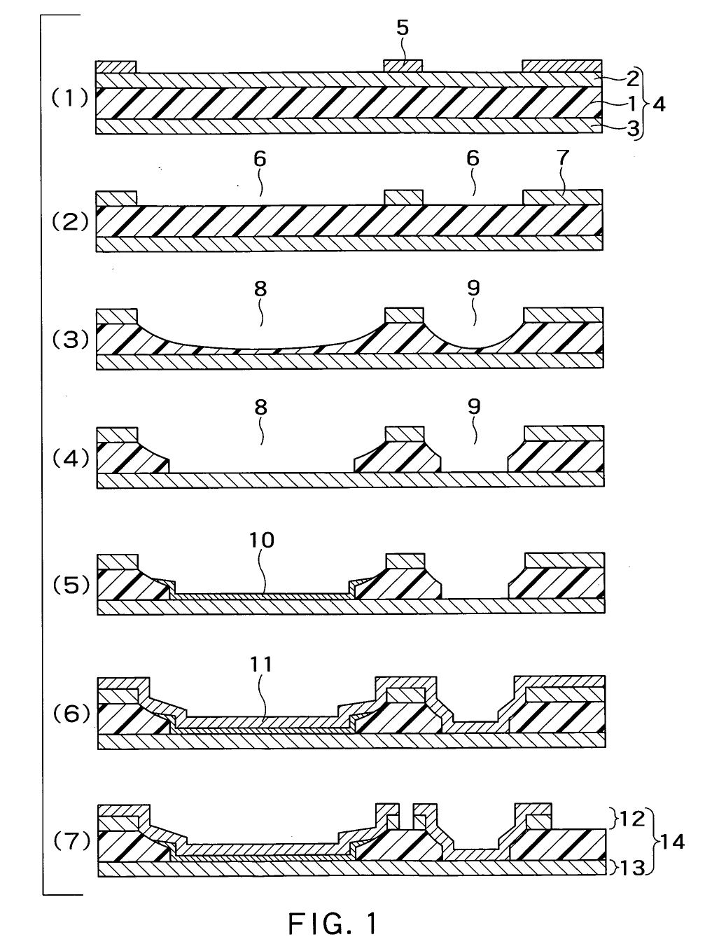

FIGS. 1(1) to 1(7) are cross-sectional process diagrams showing the method for manufacturing a printed wiring board with a built-in capacitor structure according to an embodiment of the present invention. In this method, first, as shown in FIG. 1(1), a so-called double-sided copper-clad laminate 4 is prepared. The double-sided copper-clad laminate 4 includes a flexible insulating base material 1 made of polyimide or the like, a first metal foil 2 on one side and a second metal foil 3 on the other side, each of the metal foils formed of a copper foil or the like. A resist layer 5 is provided to form a metal mask having openings at the locations where holes are formed at predetermined positions in the first metal foil 2 by using etching in a typical photofabrication approach.

This process is preferably carried out by using a laminator or the like to attach a dry film resist or the like. In this method, 25 μm-thick polyimide is used as the base material.

Then, as shown in FIG. 1(2), the resist layer 5 is used to form a metal mask 7 having openings 6 at the locations where holes are formed by using etching in a typical photofabrication approach.

Then, as shown in FIG. 1(3), any of laser processing, plasma etching, resin etching and the like or any combination thereof is used to reduce the thickness of the flexible insulating base material 1 exposed in the openings 6 provided for a hole 8 for forming a capacitor and a hole 9 for forming a via hole. In this process, chemical solution-based resin etching is used.

In this case, considering that the resin etching rate varies depending on the type of the polyimide film, preferred examples of the flexible insulating base material 1 are polyimide films obtained by polycondensation between pyromellitic dianhydride and aromatic diamine (Kapton manufactured by DuPont, USA, and Apical manufactured by Kanegafuchi Chemical Industry Co., Ltd., for example) and similarly structured polyimide.

The amount of removal of the insulating base material is preferably selected in such a way that the resultant smallest thickness is approximately 5 μm. The reason why the thickness of the insulating base material is reduced is to improve the accuracy in the area of the insulating base material removed by laser processing or the like with a small number of shots in the following process, and form an inclined surface extending from the periphery of the metal mask toward the center of the hole in order to form a step in the wall of the hole.

The capacitance of the capacitor is determined by the area of the electrodes, distance between the electrodes, and the relative dielectric constant between the electrodes, and defining the area of the electrodes in a highly accurate manner greatly contributes to improvement in accuracy in capacitance. Therefore, for an application that requires a capacitance tolerance of approximately 1 to 5%, for example, in the case of an EMI filter capacitor, laser processing or the like may be used to define the area of the electrodes, while for an application that requires a capacitance tolerance of approximately 10 to 20%, for example, in the case of a small high-frequency capacitor and a decoupling capacitor, only chemical solution-based resin etching may be used to remove the interlayer insulating film.

Then, as shown in FIG. 1(4), the insulating base material, the thickness of which has been reduced, is removed by laser processing or the like to form the hole 8 for forming a capacitor and the hole 9 for forming a via hole, each of the holes having a bottom where the hole reaches the metal foil 3 on the other side. In this process, a UV-YAG laser is used to remove the insulating base material, the thickness of which has been reduced, to form a step in the wall of the hole, the diameter of the removed insulating base material being smaller than the diameter of the opening formed in the metal mask by 80 μm.

The reason why the insulating base material, the thickness of which has been reduced, is removed from the portion whose diameter is smaller than the diameter of the opening is that when the dielectric material is applied in the following process, by allowing the dielectric material to reach the step in the wall of the insulating base material, short circuit and leakage in the capacitor structure are reliably prevented.

By removing the insulating base material from the portion whose diameter is smaller than the diameter of the opening by 80 μm, a clearance of 40 μm is provided on both sides, which is sufficient in consideration of the alignment accuracy in laser processing or the like and alignment accuracy in ink jetting.

Then, as shown in FIG. 1(5), ink jetting is used to apply a dielectric layer 10 on the second metal foil exposed in the hole 8, followed by thermal cure. In this process, to prevent short circuit in the capacitor structure, it is necessary to seamlessly form the dielectric layer 10 on the second metal foil 3.

As shown in FIG. 1(5), the dielectric layer 10 is formed in such a way that it reaches the step in the wall of the hole formed in the flexible insulating base material 1. Since a decoupling capacitor requires an area of approximately 100 mm² in the method according to the present invention, it is also effective to use screen printing for the bottom while using ink jetting for the wall.

When an electrodeposited polyimide is used as the dielectric material, the portion where polyimide should not be precipitated must be protected with a masking tape or the like. Use of paste having a high dielectric constant, however, allows application only at an arbitrary location by ink jetting or screen printing, so that the process can be simplified and an arbitrary capacitance value can be obtained by changing the relative dielectric constant, the film thickness, and the application area of the dielectric material.

Since the ink for ink jetting includes more solvent than that contained in the paste for screen printing, reduction in film thickness after thermal cure is accordingly greater. Therefore, the thickness of the dielectric material formed by ink jetting is smaller than that of the dielectric material formed by screen printing even when the ink used in the ink jetting has the same dielectric constant as that in the screen printing, so that a higher-capacitance capacitor can be formed.

When the dielectric material is drawn by ink jetting, irregularities of approximately 1.5 μm are created in the surface after the first drawing. However, repeating the drawing three times reduces the size of the irregularities in the surface to approximately 0.2 μm when the film thickness is approximately 3.5 μm. In this process, to reliably prevent short circuit due to pinholes, the drawing is repeated five times to achieve a film thickness of 5 μm.

Then, as shown in FIG. 1(6), a conducting process is carried out on the first metal foil 2, the dielectric layer 10 applied on the upper surface of the second metal foil 3 exposed in the hole 8, the wall of the hole 8, the upper surface of the second metal foil 3 exposed in the hole 9, and the wall of the hole 9 to form a plated film 11.

Then, as shown in FIG. 1(7), etching in a photofabrication approach is applied on the first metal foil 2, the second metal foil 3, and the plated film 11 to form wiring patterns 12 and 13. A double-sided flexible printed wiring board 14 with the built-in capacitor structure is thus provided.

As an example of the design of the capacitor in the above embodiment, when a dielectric film having a thickness of 5 μm and an area of 100 mm² is left on the second metal foil, the capacitance is determined by the following equation (1) to be approximately 0.005 μF.

C=∈₀×∈ᵣ×s/d (1)

where “C” is the capacitance (F), “∈₀” is the dielectric constant in a vacuum (8.85×10¹² F/m), “∈ᵣ” is the relative dielectric constant (approximately 60 when the dielectric paste “CX-16” manufactured by Asahi Chemical Research Laboratory Co, Ltd. is used), “s” is the area (mm²), and “d” is the thickness (m).

A capacitor of this size can be built under a chip component, such as a QFP (Quad Flat Package: a surface mounting component with lead pins extended from the four sides of the IC package), mounted on a wiring board, allowing a higher density.

The capacitance on the printed wiring board can be arbitrarily controlled by changing the thickness and the area of the dielectric material. For example, since the capacitance of a small high-frequency capacitor used in a mobile phone or the like is approximately 0.1 to 1 pF, the capacitor can be manufactured to have the size of the type 0402 (size: 0.4 mm long by 0.2 mm wide by 0.2 mm high) or smaller. In practice, the dielectric paste having a thickness of 5 μm and a diameter of 50 μm can provide a capacitance of 0.2 pF. The mounting area can therefore be greatly reduced.

It is also possible to fabricate a multilayer wiring board using the double-sided printed wiring board with a built-in capacitor structure according to the present invention as a core wiring board. The double-sided printed wiring board with a built-in capacitor structure according to the present invention, which can of course be applied to form a build-up layer, can be used as a core wiring board and a build-up layer.

What is claimed is:

1. A method for manufacturing a printed wiring board with built-in capacitors, the method comprising:
the first process of preparing an insulating base material having a first metal foil on one side and a second metal foil on the other side;
the second process of providing an opening in the first metal foil, the opening serving as a metal mask;
the third process of using the metal mask to remove the insulating base material exposed in the opening in the metal mask in such a way that a continuous inclined surface is provided from the periphery toward the center of the metal mask;
the fourth process of removing the insulating base material, the surface of which is inclined, until the second metal foil is exposed, the removed portion having a diameter smaller than the metal mask;
the fifth process of forming a dielectric layer by a printing method in such a way that the dielectric layer covers the second metal foil exposed by removing the insulating base material, the covered area being smaller than the metal mask but larger than the second metal foil exposed by removing the insulating base material; and
the sixth process of forming a conductive layer on the dielectric layer and using the conductive layer as a first electrode and the surface of the second metal foil that is in contact with the dielectric layer as a second electrode.

2. The method for manufacturing a printed wiring board according to claim 1, wherein the third process of removing the insulating base material is carried out by at least any one of laser processing, plasma etching, and chemical solution-based resin etching.

3. The method for manufacturing a printed wiring board according to claim 1, wherein the fourth process of removing the insulating base material is carried out by laser processing.

4. The method for manufacturing a printed wiring board according to claim 1, wherein the fourth process of removing the insulating base material is carried out by chemical solution treatment.
